(19) United States
(12) Patent Application Publication
(10) Pub. No.: US 2009/0241515 A1
(43) Pub. Date: Oct. 1, 2009

(54) EXHAUST CONDENSATION SEPARATOR

(75) Inventor: Robert Cardno, Novi, MI (US)

Correspondence Address: HARNESS, DICKEY & PIERCE, P.L.C., P.O. BOX 828, BLOOMFIELD HILLS, MI, 48303, US

(73) Assignee: DENSO INTERNATIONAL AMERICA, INC., Southfield, MI (US)

(21) Appl. No.: 12/055,379

(22) Filed: Mar. 26, 2008

(51) Int. Cl. F02M 25/07

(52) U.S. Cl. 60/278; 60/309

(57) ABSTRACT

An exhaust gas recirculation system disposed between an exhaust system and an intake system incorporates a water separator which separates acidic water from the exhaust gas prior to the exhaust gas being sent to the intake system of the engine. The water collected by the water separator is sent back to the exhaust system at a position downstream from the exhaust gas recirculation system.

### FIELD

The present disclosure relates to an exhaust gas recirculation system. More particularly, the present disclosure relates to a low pressure loop exhaust gas recirculation system that removes condensed water from the recirculated exhaust gas.

### BACKGROUND

The statements in this section merely provide background information related to the present disclosure and may not constitute prior art.

Exhaust systems perform several functions for a modern engine. For example, the exhaust system is expected to manage heat, reduce pollutants, control noise and sometimes filter particulate matter. Generally, these individual functions are performed by separate and distinct components. The engine exhaust system may use a set of heat exchangers to capture and dissipate heat. A separate muffler may be coupled to the exhaust outlet to control noise, while a catalytic converter assembly may be placed in the exhaust path to reduce non-particulate pollutants. Although today, the removal of particulates is generally directed to diesel engines, with the current focus on a “green” car, particulate emissions for vehicles using fuels other than diesel fuel may soon be required.

Internal combustion engines function by burning fuels (hydrocarbons) at high temperatures. In theory, the products of the combustion process are CO₂ and water. It is not uncommon for incomplete combustion to occur which results in the formation of undesirable byproducts such as carbon monoxide, hydrocarbons and soot. Other reactions occurring in internal combustion engines include the oxidation on nitrogen molecules to produce nitrogen oxides and the oxidation of sulfur to form SO₂ and a small percentage of SO₃. Further, when the temperature decreases, the SO₃ can react with H₂O to form sulfuric acid. Other inorganic materials are formed as ash.

The products of these reactions result in undesirable gaseous, liquid and solid emissions from internal combustion engines. In order to improve engine emissions under medium and high load conditions, the use of a low pressure loop exhaust gas recirculation system has been developed. The low pressure loop exhaust gas recirculation system creates an exhaust gas pathway from a location downstream of a catalytic converter and/or a particulate filter to a location downstream of the intake air cleaner. This pathway typically consists of an exhaust gas recirculation cooler, an exhaust gas recirculation gas control valve and the piping necessary to connect all of these components.

Although this system provides better NOₓ emissions performance, when the exhaust gas in the exhaust gas recirculation cooler cools the exhaust gas, acidic water condenses into the exhaust gas recirculation flow and is directed to the internal combustion engine with the recirculated exhaust gas. Thus, the induction system and other various components of the internal combustion engine have this acidic water deposited on them. This acidic water can damage the existing components and this may cause the development engineers to change materials and designs for these components which may increase their costs, increase their weights and lower their performance inefficiencies.

### SUMMARY

The present disclosure provides a solution to this problem by providing a device which removes acidic water from the exhaust gas recirculation gas flow. By removing acidic water from the exhaust gas recirculation gas flow, the downstream induction system and other components of the internal combustion engine are not adversely affected by the acidic water and the damaging effects of the contaminant.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a schematic view of an exhaust gas recirculation system which includes the low pressure loop exhaust gas recirculation system in accordance with the present disclosure;

FIG. 2 is an enlarged schematic view of the low pressure loop of the exhaust gas recirculation system illustrated in FIG. 1;

FIG. 3 is a side perspective view of the water separator in the low pressure loop illustrated in FIGS. 1 and 2;

FIG. 4 is an end perspective view of the water separator illustrated in FIGS. 1-3; and

FIG. 5 is a side perspective view in cross-section of the water separator illustrated in FIGS. 1-4.

### DESCRIPTION

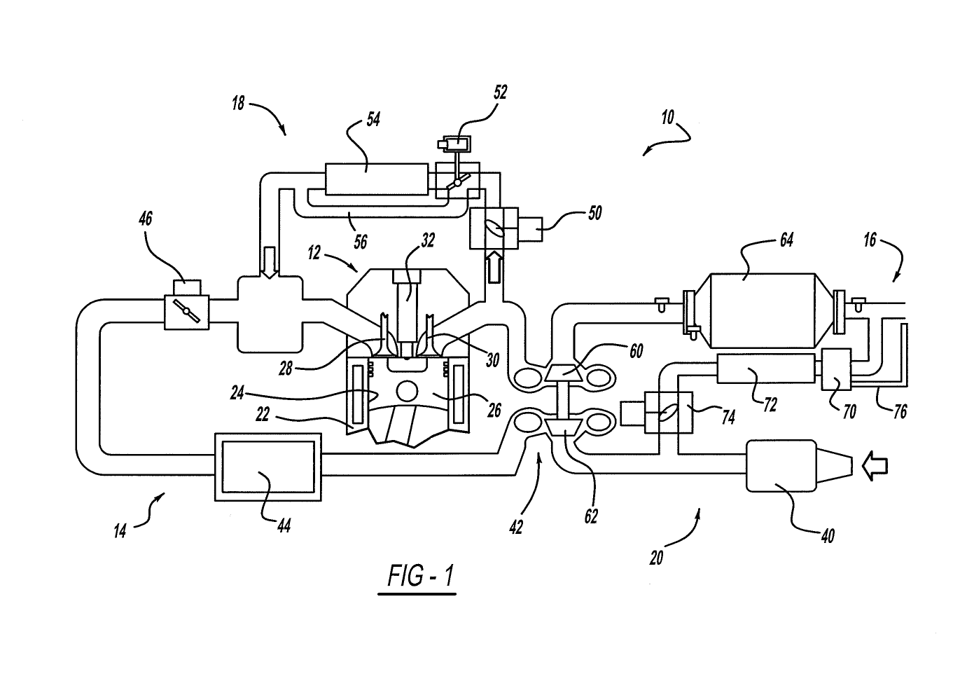

The following description is merely exemplary in nature and is not intended to limit the present disclosure, application, or uses. There is illustrated in FIG. 1 a vehicle power system which is indicated generally by the reference numeral 10. Vehicle power system 10 comprises an internal combustion engine 12 and an intake and exhaust gas handling system in the form of an intake system 14, an exhaust system 16, a high pressure loop exhaust gas recirculation (HPL-EGR) system 18, a low pressure loop exhaust gas recirculation (LPL-EGR) system 20.

Internal combustion engine 12 comprises an engine block 22 defining a plurality of cylinders 24. A piston 26 is slidingly received within each cylinder 24. An intake valve 28 opens into each cylinder 24 to provide an intake charge and an exhaust valve 30 opens into each cylinder 24 to expel the products of combustion. A fuel injector 32 is disposed in each cylinder to supply the fuel for the combustion process. As is well known in the art, the motion of the piston is synchronized with the opening and closing of intake valve 28, the opening and closing of exhaust valve 30 and the supplying of fuel from fuel injector 32 such that internal combustion engine 12 runs to provide power to operate the vehicle. In diesel engines a glow plug (not shown) can be provided in each cylinder as is well known in the art and in a gasoline engine a spark plug or other means for initiating the combustion process can be disposed in each cylinder as is well known in the art.

Intake system 14 comprises an air cleaner 40 through which outside air is provided to internal combustion engine 12, a turbo-charger 42 which increases the pressure of the air being supplied to internal combustion engine 12, an intercooler 44 which cools the air being supplied to internal combustion engine 12 and a throttle valve 46 which controls the flow of intake charge to internal combustion engine 12.

HPL-EGR system 18 comprises an exhaust gas recirculation valve 50, a switching valve 52 and an exhaust gas recirculation cooler 54. HPL-EGR system 18 receives exhaust gas from exhaust system 16 immediately after the combustion process and it routes this exhaust gas back into intake system 14 downstream from throttle valve 46. Exhaust gas recirculation valve 50 controls the flow of exhaust gas through HPL-EGR system 18 based upon a control program resident in the vehicle's engine control module (not shown). Also, switching valve 52 routes the exhaust gas into exhaust gas recirculation cooler 54 or into a bypass 56 based on the control program resident in the vehicle's engine control module.

Between HPL-EGR system 18 and LPL-EGR system 20, exhaust system 16 is routed through turbo-charger 42 where the exhaust gas powers a turbine 60 which in turn powers a compressor 62 which increases the pressure of the air being supplied to internal combustion engine 12. After leaving turbine 60 of turbo-charger 42, exhaust system 16 is routed through a particulate filter 64 (for diesel applications) and it is then routed to a muffler and possibly a catalytic converter prior to being released to the atmosphere.

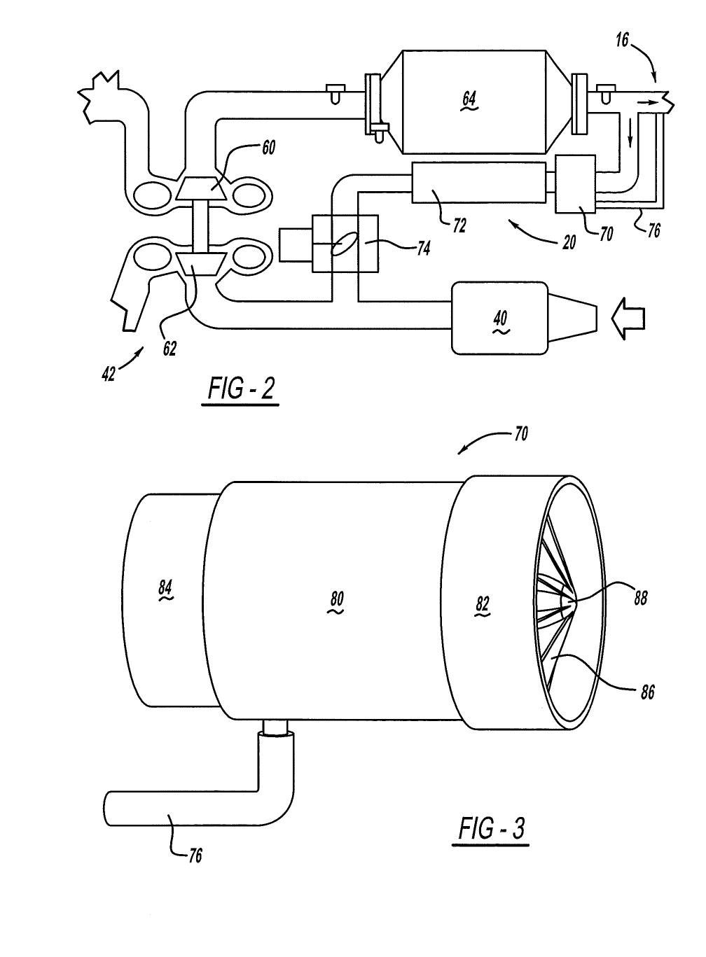

Referring now to FIG. 2, LPL-EGR system 20 comprises a water separator 70, an exhaust gas recirculation cooler 72 and an exhaust gas recirculation valve 74. LPL-EGR system 20 receives the exhaust gas from exhaust system 16 immediately downstream from particulate filter 64 (if present) and it returns the exhaust gas to intake system 14 immediately downstream from air cleaner 40. LPL-EGR system 20 can receive exhaust gas upstream of the catalytic converter as long as the water drain line discussed below empties upstream of the catalytic converter in order to avoid creating a catalytic converter bypass loop.

Water separator 70 receives the exhaust gas and removes water from the exhaust gas as described below. Since this water is the acidic water that can present problems with internal combustion engine 12 and intake system 14, the removal of this water reduces and/or eliminates these problems. The water collected by water separator 70 is returned to the exhaust gas flow through a drain tube or water line 76 which enters the exhaust gas flow at a position downstream of where LPL-EGR system 20 receives the exhaust gas from exhaust system 16. From water separator 70, the exhaust gas is directed through exhaust gas recirculation cooler 72 to be cooled and the exhaust gas is expelled into intake system 14. Exhaust gas recirculation valve 74 controls the flow of exhaust gas through LPL-EGR system 20 based on commands received from the program resident in the vehicle's engine control module.

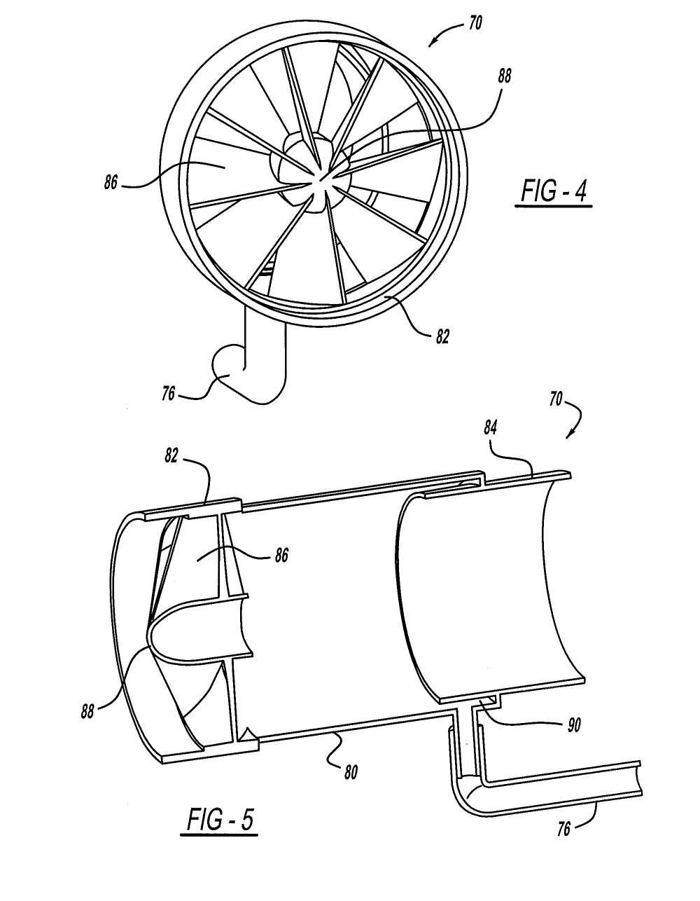

Referring now to FIGS. 3-5, water separator 70 is illustrated. Water separator 70 comprises an inlet tube 80, a fixed blade turbine 82 and an outlet tube 84. Fixed blade turbine 82 is disposed within inlet tube 80 and the exhaust gas is routed into inlet tube 80. Fixed blade turbine 82 has a plurality of blades 86 that extend radially from the centerline of inlet tube 80 to the wall of inlet tube 80 such that all the exhaust gas flowing in inlet tube 80 is directed into fixed blade turbine 82 which is fixedly secured to inlet tube 80. An aerodynamic core 88 is located at the center of fixed blade turbine 82 to direct the exhaust gas flow smoothly into turbine blades 86. Turbine blades 86 have a constantly curved outer surface as they transition from aerodynamic core 88 to the wall of inlet tube 80. This constantly curved surface imparts a rotation to the exhaust gas which causes centrifugal forces to act upon the exhaust gas and upon the products in the exhaust gas flow. The products in the exhaust gas flow will migrate outwards due to this centrifugal force to the wall of inlet tube 80. The acidic water condensate contained in the exhaust flow is one of these products.

Outlet tube 84 is disposed downstream from fixed blade turbine 82. Outlet tube 84 is smaller in diameter than inlet tube 80 and outlet tube 84 is disposed in a co-axial arrangement with inlet tube 80. Outlet tube 84 extends into inlet tube 80 a specified distance to define a collection area 90. The end of inlet tube 80 is sealingly attached to the outside of outlet tube 84. Collection area 90 defines a particle trap which prevents the acidic water from traveling further along with the exhaust gas toward intake system 14. Water return line 76 is open to collection area 90 and drains the accumulated acidic water to a position downstream from the exhaust gas inlet to LPL-EGR system 20 in exhaust system 16.

What is claimed is:

1. An exhaust gas handling system for an internal combustion engine, said exhaust gas handling system comprising:
an intake system providing air to said internal combustion engine;
an exhaust system removing products of combustion from said internal combustion engine; and
an exhaust gas recirculation system disposed between said exhaust system and said intake system, said exhaust gas recirculation system including a water separator for removing water from exhaust gas routed from said exhaust system to said intake system by said exhaust gas recirculation system.

2. The exhaust gas handling system according to claim 1, wherein said intake system includes an air cleaner, said exhaust gas recirculation system routing said exhaust gas to said intake system at a position downstream from said air cleaner.

3. The exhaust gas handling system according to claim 2, wherein said intake system includes a turbo-charger, said exhaust gas recirculation system routing said exhaust gas to said intake system at a position upstream of said turbo-charger.

4. The exhaust gas handling system according to claim 1, wherein said water separator comprises:
an inlet tube;
an outlet tube disposed co-axial with said inlet tube; and
a turbine disposed within said inlet tube.

5. The exhaust gas handling system according to claim 4, wherein said outlet tube is disposed within said inlet tube.

6. The exhaust gas handling system according to claim 5, wherein said inlet tube and said outlet tube define a collection area between said inlet tube and said outlet tube.

7. The exhaust gas handling system according to claim 6, further comprising a drain tube in fluid communication with said collection area.

8. The exhaust gas handling system according to claim 7, wherein said drain tube is in communication with said exhaust system.

9. The exhaust gas handling system according to claim 4, wherein said turbine is fixedly secured to said inlet tube.

10. The exhaust gas handling system according to claim 9, wherein said turbine defines a plurality of blades extending radially from a centrally disposed core.

11. The exhaust gas handling system according to claim 10, wherein each of said plurality of blades defines a constantly curved outer surface.

12. The exhaust gas handling system according to claim 1, wherein said exhaust gas recirculation system further includes an exhaust gas cooler.

13. The exhaust gas handling system according to claim 12, wherein said exhaust gas recirculation system further includes an exhaust gas recirculation valve.

14. The exhaust gas handling system according to claim 1, wherein said exhaust gas recirculation system further includes an exhaust gas recirculation valve.

15. The exhaust gas handling system according to claim 1, further comprising a turbo-charger in communication with said intake system and said exhaust system; wherein
said exhaust gas recirculation system communicates with said exhaust system at a point downstream from said turbo-charger; and
said exhaust gas recirculation system communicates with said intake system at a point upstream of said turbo-charger.
